(19) United States
(12) Patent Application Publication
(10) Pub. No.: US 2008/0264489 A1
(43) Pub. Date: Oct. 30, 2008

(54) Method and a Device for Handling a Liquid

(76) Inventor: Christian Erik Naustdal, Stathelle (NO)

Correspondence Address: WENDEROTH, LIND & PONACK, L.L.P., 2033 K STREET N. W., SUITE 800, WASHINGTON, DC, 20006-1021, US

(21) Appl. No.: 11/628,049

(22) PCT Filed: May 25, 2005
(86) PCT No.: PCT/NO05/00174

§ 371 Date: Jan. 23, 2007

(30) Foreign Application Priority Data
Jun. 4, 2004 (NO) 20042319

(51) Int. Cl. F17D 1/00; F17D 3/01; F02M 29/04

(52) U.S. Cl. 137/7; 261/114.5; 261/113

(57) ABSTRACT

The present invention relates to a method and a column to handle foaming liquids or high viscous liquids and prevent flooding in liquid-gas mass transfer operations. Said operation is carried out by using higher or equal pressure at the liquid inlet than at the liquid outlet in said column. Said column comprises a single shell (7) housing at least one tray, where said shell is provided with at least one liquid inlet (1), one liquid outlet (11), one separate gas inlet (5) for each of said trays and at least one outlet (2) for gas leaving said column.

The present invention relates to a method to handle foaming liquids or high viscous liquids and prevent flooding in liquid-gas mass transfer operations and a column utilized for such operations.

Liquid-gas mass transfer operations and process equipment utilized for such operations are described by R. H. Perry and C. H. Chilton in Chemical Engineers' Handbook. Said conventional process equipment, however, utilizing columns for liquid-gas contact will have problem with handling foamy and high viscous liquids.

A conventional plate or packed column has one inlet and one outlet for gas. If a foaming liquid is fed to a conventional plate or packed column, experiments have shown that the liquid will foam and cause flooding in the column. When flooding, the liquid will be carried out with the gas leaving the top of the column and no liquid will leave the liquid outlet in the bottom of the column due to higher pressure in the bottom of the column.

In said columns anti foaming agents are in common use to prevent foaming. This impacts the cost and performance of the operation of the column and may also give negative effects on the product properties and environment. Some foaming liquids as for instance PVC (poly vinyl chloride) latex, foam to a degree that prevents stripping in a conventional column for removal of unreacted VCM (vinyl chloride monomer) despite use of anti foaming agent.

To enable operation with foaming liquids wetted-wall column or spray chamber may be used, but the residence time may be too short to obtain an effective liquid-gas mass transfer, especially if the liquid contains solid matter. The laws of diffusion will determine the liquid-gas mass transfer between solid, liquid and gas and high residence time may be necessary when the liquid contains solid matter as for instance liquid slurries and latexes.

The main objective of the present invention was to arrive at a method to handle foaming liquids or high viscous liquids and prevent flooding in liquid-gas mass transfer operations.

Another objective of the present invention was to arrive at a column for carrying out said method.

These objectives are achieved in accordance with the present invention by using higher or equal pressure at the liquid inlet than at the liquid outlet. Consequently, the foamy liquid will be forced down through the column without being carried out with the gas flowing counter-currently to the liquid. Flooding is avoided.

In a conventional column the pressure difference between two trays is determined by the pressure of the liquid static height on the tray and the pressure loss through the tray. In a column according to the present invention, however, a tray comprises a tray plate, a basin plate below said tray plate and/or a weir and/or a down-comer. Hence, said tray will eliminate the pressure of the liquid static height and the pressure drop of gas through the plate to control the column pressure. Furthermore, the gas is fed to said tray through a gas inlet and flows into the chamber formed by said tray plate and basin plate preventing gas in the column to enter and pass through the trays. The chamber made by the tray plate and the basin plate has a higher pressure than inside of the column. The gas is then forced not to enter the column without going through the tray. Hence the column can be operated with a higher or equal pressure at the liquid inlet than at the liquid outlet. This way of operating said column requires one or more outlets for gas from said column and one separate gas inlet for each tray. Higher or equal pressure at the liquid inlet than at the liquid outlet can be obtained by utilizing several gas outlets with different pressure drops. By adjusting the inlet flow and pressure gradient in the column, a proper residence time can be obtained giving an effective liquid-gas mass transfer even with high viscous liquids or liquids with high foaming tendency.

The basin plate below the tray plate is an important feature in the present invention as well as one or more outlets for gas from the column and one separate gas inlet for each tray.

The column may have one tray or several trays. Several columns can be installed in series. Alternatively, packing material can be used instead of tray plates.

Hence, the disadvantages of conventional liquid-gas mass transfer operations and conventional columns are avoided by means of the present invention.

The present invention can be applied to foaming liquids and high viscous liquids which cannot be handled in a conventional column as for instance liquids containing surfactants, food industry liquids and high viscous oil distillates (asphalt).

The invention will be further explained and envisaged in the following figures and examples.

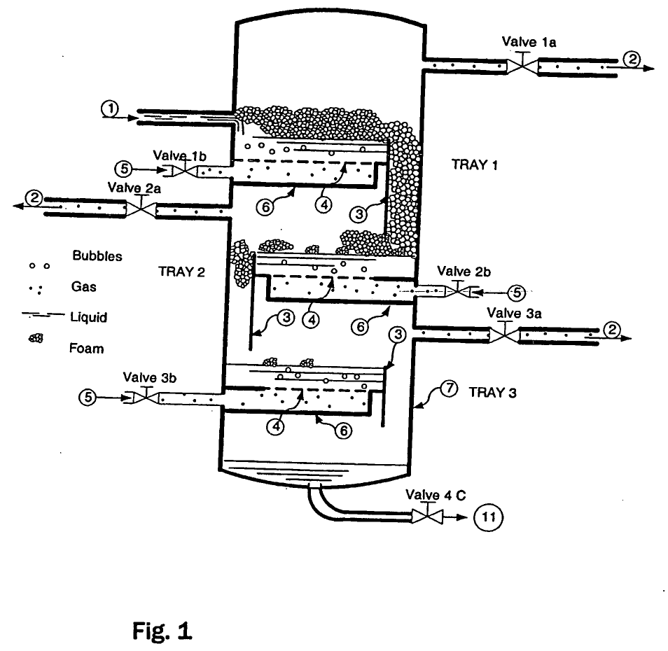

FIG. 1 shows schematically a vertical cross-section of a column in accordance with the present invention.

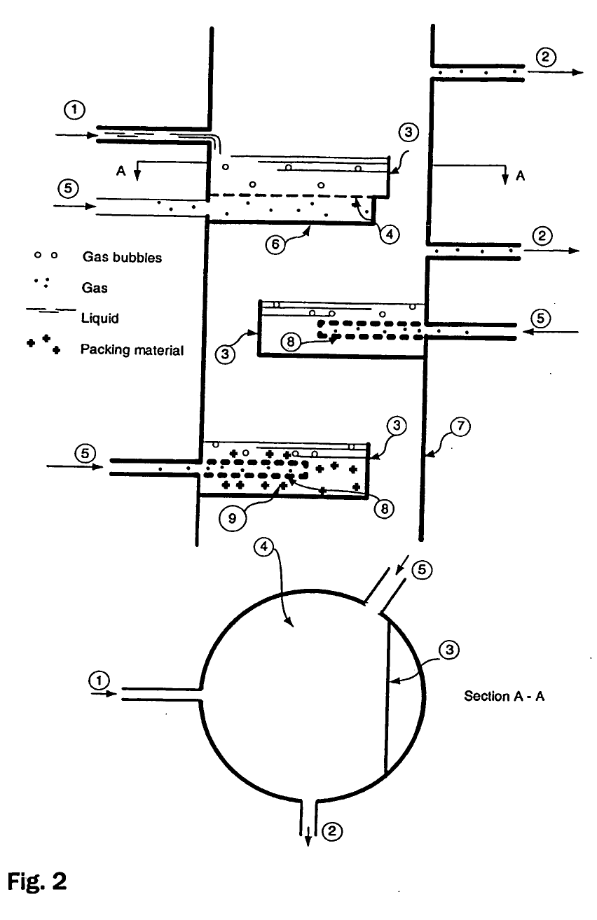

FIG. 2 shows schematically a vertical cross-section of alternative designs of a tray in a column in accordance with the present invention.

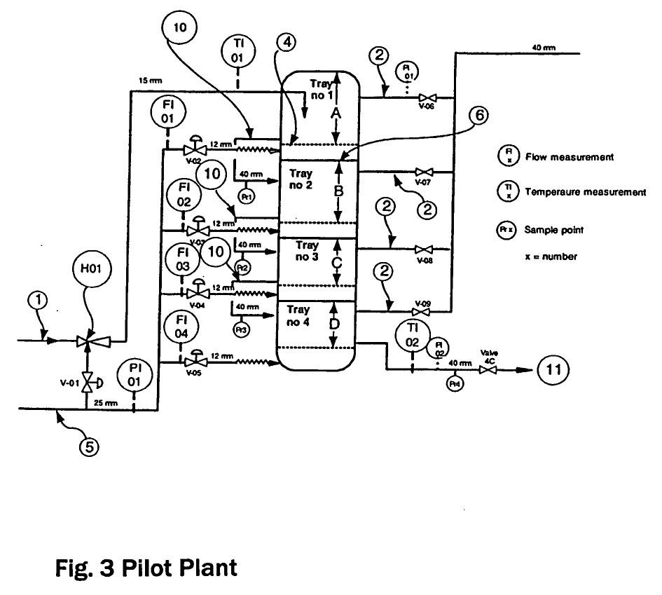

FIG. 3 shows schematically an example of a pilot plant for performing a liquid-gas mass transfer operation in accordance with the present invention.

FIG. 1 shows a vertical cross-section of a column with three trays (trays 1,2,3), one liquid inlet 1, one liquid outlet 11, one gas inlet 5 for each tray and one gas outlet 2 from each tray.

A liquid with foaming tendency is fed into the column through pipe 1. The liquid will start foaming and follow the gas through valve 1a. To prevent this undesirable flow of foam, the valve 1a is closed and the foam and the gas from tray 1 are forced from tray 1 to tray 2. The valve 1a is then gradually opened letting gas flow out of valve 1a but keeping the pressure in tray 1 above or equal to the pressure in tray 2 to a point where the foam still is forced from tray 1 to tray 2. Similar procedure is applied to gas outlet valve 2a and then gas outlet valve 3a to get the foaming liquid further downstream in the column. Downstream of the outlet valves the pressure is maintained at the same level for all outlets (e.g. atmosphere). The gas is entering the column through pipe(s) 5, valves 1b, 2b and 3b and tray plates 4 and flows out of the column through the outlet valves 1a, 2a, 3a, respectively and further through pipe(s) 2. Bottom plate(s) 6 is a basin plate and prevents that gas enters the column without going through tray plate 4. Said plate 6 is important due to the fact that it prevents influence on column pressure. Each tray can be equipped with a weir or/and a down-comer 3. The height of the weir influences the residence time in the column as this will change the liquid volume in the tray. The height of the weir/down-comer 3 can be from zero to several meters. The liquid level in the bottom of the column is controlled by valve 4c. 7 is the column wall.

The column pressure is then adjusted with a higher or equal pressure in the top of the column than in the bottom of the column. The pressure difference between tray 1 and tray 2 and the gravity force must overcome the resistance of flow of the froth, foam, liquid and gas from tray 1 to tray 2. This forces the liquid to flow from the liquid inlet to the liquid outlet of the column in spite of high viscosity or foam. If the foam formation increases during operation, an alternative method to increase the pressure above tray 1 is to increase the gas flow to tray 1 through valve 1b. This will increase the pressure on tray 1 and force the liquid from tray 1 to tray 2.

FIG. 2 shows alternative designs of trays in a column in accordance with the present invention. Pipe 1 is the liquid inlet, pipe 2 is a gas outlet, 3 is a weir/a down-comer, 4 is a sieve plate, pipe 5 is a gas inlet, 6 is the basin plate, 7 is the column wall, 8 is a perforated pipe which is an alternative distribution device for gas in the tray compared to the sieve tray or tray plate and 9 is a packing material to enhance the distribution of gas in the tray.

FIG. 3 illustrates a pilot plant for performing a liquid-mass transfer operation in accordance with the present invention. Pipe 1 is the liquid inlet, H01 is a direct steam heater, pipe 2 is a gas outlet, 4 is the first sieve tray, 6 is the basin plate, 10 is an outside down-comer (same function as inside down-comer 3 in FIG. 1). A, B, C and D is the distance between a sieve tray and a basin plate. V01 is a gas control valve to H01. V02, V03 and V04 are gas inlet control valves corresponding to 1b, 2b, 3b in FIG. 1. V06, V07 and V08 are gas outlet control valves corresponding to 1a, 2a, 3a in FIG. 1. Pr1, Pr2, Pr3 and Pr4 are sampling points. PI01 and PI02 are pressure measurements. Valve 4c is used to control the liquid level on tray 4.

To the inventor's surprise the tendency to foam formation was reduced for each tray downstream tray 1. This effect is depending on residence time, as a longer residence time reduces foam which is observed by less foaming downwards in the column.

This effect can be utilised in a conventional column as for instance described in U.S. Pat. No. 4,297,483, by using the present invention as a replacement for the top tray(s). This will make said column able to handle foaming liquids without the use of anti foaming agents.

Another advantage is that the residence time can be controlled over a large range because the weir height and hence the pressure from the liquid volume does not control the pressure in the tray below.

If the gas and liquid flows are maintained as described above, the tray plate(s) 4 can be designed with high pressure drop due to the basin plate and with a wide range of designs as e.g. sieve, valve, bubble cup, packed and sintered.

Due to the design the column in accordance with the present invention can be operated both above and under atmospheric pressure and at a wide range of temperatures. In a sieve tray plate the hole diameter can vary from below 0.01 mm (sinter metal) to above 10 mm, typical 1.5 mm. Residence time can be designed by selecting the weir height for a given column to be less than 1 sec. to several hours.

### EXAMPLE 1 STRIPPING OF PASTE PVC FOR REMOVAL OF UNREACTED VCM

Continuous stripping of paste PVC (polyvinyl chloride) was performed in a four-tray plate column in accordance with the present invention for removal of unreacted vinyl chloride monomer (VCM). The column is shown in FIG. 3.

Diameter of the column: 150 mm

Distance A: 1100 mm

Distance B: 1190 mm

Distance C: 880 mm

Distance D: 880 mm

Diameter gas outlets 2: 40 mm

Sieve tray plate thickness: 5 mm

No. of holes in tray plates: 12

Hole diameter in tray plates: 2 mm

Temperature tray 4: 54° C.

Foaming emulsion PVC latex with a dry matter content of 40% and average particle size of 200 nm was fed through tray no. 1 and out of tray no. 4. The latex floated from tray no. 1 to tray no. 2 through pipe 10 and further through tray 2 and tray 3 to the outlet. The concentration of VCM in the feed was 554 ppm. Pressure at tray no. 1 was equal to 0.02 bar higher than at tray no. 2, pressure at tray no. 3 was 0.005 bar lower than at tray no. 2, pressure at tray no. 4 is 0.0005 bar lower than at tray no. 3. The pressure at tray no. 4 was 0.15 bar. Steam was used as inert gas with a pressure of 4.5 bar.

The result of the stripping process is shown in Table 1.

TABLE 1

| | Estimated | VCM (ppm) | | | Steam flow |
|---|---|---|---|---|---|
| Test | residence | in stripped | | | m³/h at |
| no. | time (min) | PVC | Flow (l/min) | Tray no. | 4.5 bar |
| 1 | 0.34 | 11 | 0.59 | 1 | 3 |
| | 0.68 | 1.5 | 0.59 | 2 | 2.5 |
| | 1.01 | 0.5 | 0.59 | 3 | 1.5 |
| | 1.35 | 0.2 | 0.59 | 4 | 0.5 |
| 2 | 0.30 | 62 | 1.1 | 1 | 3 |
| | 0.60 | 13 | 1.1 | 2 | 2.5 |
| | 0.89 | 6 | 1.1 | 3 | 1.5 |
| | 1.19 | 3 | 1.1 | 4 | 0.5 |
| 3 | 0.18 | 19 | 1.48 | 1 | 3 |
| | 0.36 | 3.8 | 1.48 | 2 | 2.5 |
| | 0.54 | 2.6 | 1.48 | 3 | 1.5 |
| | 0.72 | 1.4 | 1.48 | 4 | 0.5 |

As shown in Table 1 the VCM level decreases with increasing residence time and number of trays and reaches a very low level. In a conventional column, stripping is not possible due to foaming, as shown in the comparative example.

### EXAMPLE 2 STEAM DISTILLATION OF LATEX WITH POROUS POLYSTYRENE PARTICLES FOR REMOVAL OF RESIDUAL PENTYL ACETATE FROM THE PARTICLES

Steam distillation of latex with porous polystyrene particles for removal of residual pentyl acetate (b.p. 140° C.) from said particles was performed in a column with a design similar to said column in FIG. 3 and with data given below.

Column diameter: 300 mm

No. of trays: 3

Tray distance: 1500 mm

Pressure tray 3: 0.4 bar

Temperature tray 3: 76° C.

Pressure trays 1 and 2: slightly above 0.4 bar

Feed rate: 178 kg/h

Steam feed rate: 57 kg/h (sum of all trays)

Dry matter of polystyrene particles in feed: 17.8 kg/h

Pentyl acetate in feed: 16.8 kg/h

Pentyl acetate in gas outlet: 16.46 kg/h

Polystyrene particles in gas outlet: 0 kg/h

Pentyl acetate in liquid latex: 0.34 kg/h

Average residence time: 25 min

This example shows that it was possible to remove approx. 98% of pentyl acetate from the liquid latex while this is not possible when utilizing a conventional column as shown in the comparative example.

### EXAMPLE 3 HANDLING OF A FOAMING LIQUID

Water containing 0.2 weight % sodium dodecyl sulphate was run in the same column as utilized in Example 2 to demonstrate that a heavy foaming liquid will flow from liquid inlet to liquid outlet without any foam in the gas outlet.

Pressure tray 3: 0.4 bar

Pressure trays 1 and 2: slightly above 0.4 bar

Feed rate: 150 kg/h

Steam feed rate: 50 kg/h (sum of all trays)

All foam and liquid followed the liquid outlet which demonstrate that said column according to the present invention works as described.

### COMPARATIVE EXAMPLE

The liquid in Examples 1, 2 and 3 was run in a conventional sieve tray column.

Column diameter: 150 mm

Tray distance: 300 mm

Distance top tray to gas outlet: 2000 mm

No. of holes in tray plate: 22

Hole diameter in tray plate: 4 mm

No. of trays: 5

Weir height: varied from 5 mm to 250 mm

Down-comer height: varied from 60 mm to 296 mm

Temperature: 55° C.

Pressure: 0.15 bar

Feed rate: 0.1-2 l/min

Steam feed rate: 0.1-4 kg/h

Column liquid outlet: 0.1-2 l/min

All liquid and foam followed the gas out of the column for all three liquids if the liquid was boiling irrespective variation in down-comer heights or weir heights. Hence, it was not possible to operate the conventional column with foaming liquids.

The examples show that a conventional column is not suitable for handling foaming liquids. A method and a column in accordance with the present invention, however, make it possible to handle foaming liquids and have shown to be very efficient in liquid-gas mass transfer operations.

1-8. (canceled)

9. A method for handling foaming or high viscous liquids to prevent flooding in a liquid-gas mass transfer operation carried out in a column comprising at least one tray, inlet and outlet for said liquid and inlet and outlet for said gas, wherein said operation is carried out with a higher or equal pressure at said liquid inlet than at said liquid outlet by feeding said gas through one separate inlet on each tray and discharging said gas through separate gas outlet(s) downstream each tray.

10. A method according to claim 9, wherein said gas is fed to said column through said gas inlet on each tray and flows further into a chamber formed by a tray plate, a basin plate below said tray plate and a down-comer.

11. A column for carrying out a method according to claim 9 comprising a single shell with inlet and outlet for said liquid and inlet and outlet for said gas housing at least one tray, wherein said column has one gas inlet for each tray.

12. A column according to claim 11, wherein said tray comprises a chamber formed by a tray plate, a basin plate below said tray plate and a down-comer preventing gas in said column to enter and pass through said trays.

13. A column according to claim 11, wherein said tray plate is a sieve plate, packing material, bubble cap tray, valve tray or perforated pipe.

14. A column according to claim 11, wherein said tray plate comprises a perforated pipe, a basin plate below said pipe and a down-comer.

15. A column according to claim 11, wherein said tray comprises a perforated pipe, a basin plate below said pipe, a packing material and a down-comer.

16. A process for removal of a component from a foaming or high viscous liquid, including:
a method for handling foaming or high viscous liquids to prevent flooding in a liquid-gas mass transfer operation carried out in a column comprising at least one tray, inlet and outlet for said liquid and inlet and outlet for said gas, wherein said operation is carried out with a higher or equal pressure at said liquid inlet than at said liquid outlet by feeding said gas through one separate inlet on each tray and discharging said gas through separate gas outlet(s) downstream each tray; and
wherein the method is carried out by a column comprising a single shell with inlet and outlet for said liquid and inlet and outlet for said gas housing at least one tray, wherein said column has one gas inlet for each tray.
